(19) United States
(12) Patent Application Publication
(10) Pub. No.: US 2004/0168540 A1
(43) Pub. Date: Sep. 2, 2004

(54) Steering device with cooling device

(76) Inventor: Michael Weiss, Benediktbeuren (DE)

Correspondence Address: Robert P. Renke, Suite 250, 28333 Telegraph Road, Southfield, MI, 48034, US

(21) Appl. No.: 10/754,032

(22) Filed: Jan. 8, 2004

(30) Foreign Application Priority Data
Jan. 8, 2003 (DE) DE 103 00 483.1

(51) Int. Cl. B62D 1/04

(52) U.S. Cl. 74/552

(57) ABSTRACT

A steering device including a cooling device arranged therein, the cooling device having at least one heat pipe including at least one heat-absorbing area and at least one heat-emitting area, the at least one heat-absorbing area being located in a grip region of the steering device.

### TECHNICAL FIELD

The present invention relates to a steering device such as a steering wheel with a cooling device. Steering devices of the generic type find application especially in regions with hot climates in order to keep the temperature of a steering device at an acceptable temperature level.

### BACKGROUND OF THE INVENTION

Because it is always necessary to grip the steering wheel of, for example, an automobile in order to operate the vehicle, there has been a longstanding need to provide an acceptably comfortable steering wheel from a temperature standpoint, particularly on very hot days. Various solutions have been proposed for cooling the steering wheel of a vehicle. For example, it is known to blow a stream of air emerging from dashboard vents and/or from an air conditioner, at the steering wheel in an attempt to cool the surface of the steering wheel. It is also known from DE 29802 to cool steering wheels with Peltier elements.

It is known from U.S. Pat. No. 6,007,420 to pass air through a hollow steering wheel and allow the air to escape through holes at the steering wheel surface.

In another example, WO 01/28842 discloses a steering wheel wherein a fluid is pumped in a closed circuit through the steering wheel, a heat exchanger, and a heat reservoir.

In another example, a steering wheel is known from U.S. Patent Application Publication No. 2002/0166407 wherein a heat storage medium that can undergo a change of state is incorporated in the steering wheel.

However, all of the prior art cooling devices for steering wheels have drawbacks including somewhat time-limited effectiveness, poor efficiency, or they are technically impractical. Thus, there remains a need for an improved steering wheel cooling system or method.

### SUMMARY OF THE INVENTION

The present invention provides a steering device with improved cooling. A steering device in accordance with one embodiment of the present invention includes a cooling device wherein the cooling device includes at least one heat pipe. A steering device in accordance with this embodiment is advantageous in that it permits the rapid removal of large amounts of heat from the steering device in a continuous process.

According to a further embodiment, the steering device includes a grip for executing steering movements and the heat pipe includes a heat-emitting region and a heat-absorbing region. The heat-absorbing functional area of the heat pipe is arranged in the grip area whereas the heat-emitting functional area of the heat pipe is arranged outside of the grip area. Such an arrangement allows installation of the cooling device in an advantageous area for the vehicle operator without interfering with other functions of the steering device.

In another embodiment, the heat-emitting functional area of the cooling device can be arranged in a center section of the steering device that is normally not touched by the vehicle operator. The heat-emitting functional area of the cooling device can be accommodated in the center section of the steering device and can be exposed to ambient air or arranged in an air stream that is not directed toward the head of the vehicle operator. Such an arrangement permits a technically simple solution for heat transmission through the cooling device without comprising operator comfort.

In another aspect of the invention, the steering device can include at least one fan or Peltier element arranged proximate the heat-emitting functional area of the cooling device to permit additional cooling of the steering device. For example, the fan or Peltier element can be arranged directly on the heat-emitting functional element to provide an increased cooling capacity. Alternatively, the fan or Peltier element can be arranged in the dashboard or instrument panel area of the vehicle to eliminate the need of additional steering wheel cabling which can increase the expense of the overall system. In another example, when a Peltier element is used, at least part of the a cooled surface of the element or part of a heated surface of the element can be arranged in the airflow from the fan to rapidly remove warm exhausted air from the steering device area or provide ambient air cooled by the Peltier element directed toward the steering device.

In another embodiment, the steering device includes a jacket surrounding the grip area and may also or alternatively include a cover surrounding the jacket which is designed to have good heat conductivity at least throughout portions thereof. For example, metal components such as powder or fibers or a thermally conductive paste may be included in the jacket or cover to improve the thermo-conductivity to the cooling device within a cross section of the steering wheel grip.

In a further aspect of the invention, the heat pipe can contain a fluid such as water which has an evaporation point of between 25° C. and 60° C. or, at typical summer temperatures, has a pressure between 0.01 bar and 0.7 bar to allow operation of the cooling device throughout the desired temperature ranges. The cooling device itself may also be switched on in response to various vehicle events such as unlocking or opening of at least one of the vehicle doors.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 shows a top view of an embodiment in partial cross-section.

FIG. 2 shows the steering wheel from FIG. 1 in cross-section.

### DETAILED DESCRIPTION OF THE INVENTION

While the present invention is described with respect to an apparatus for cooling a steering wheel of a vehicle, the present invention may be adapted and utilized for cooling other types of grip handles, not just steering wheels or steering devices. Furthermore, in the following description, various operating parameters and components are described for one constructed embodiment. These specific parameters and components are included as examples and are not meant to be limiting.

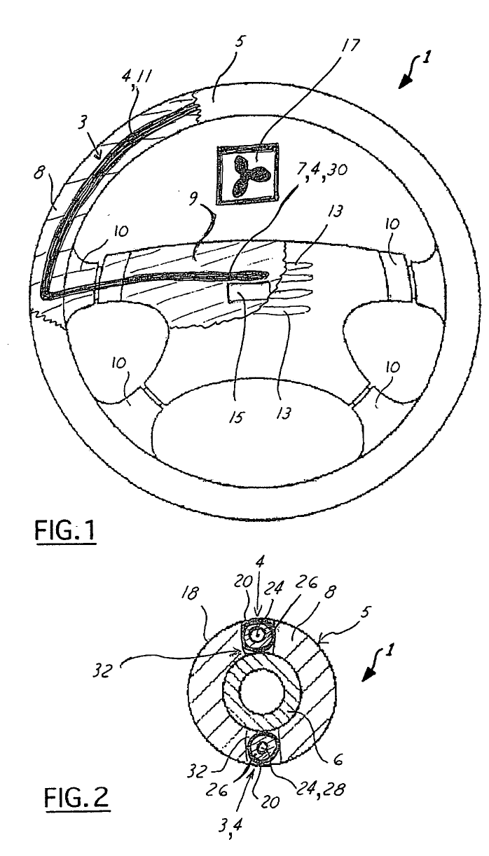

Referring now to the drawings wherein like reference numerals are used to identify identical components in the various views, FIG. 1 shows a top view of a steering device 1, here in the form of a steering wheel. The steering device 1 has a grip 5 that serves to transmit steering motions to a vehicle. The grip 5 is shown in cross-section in FIG. 2.

The grip 5 has a rigid core 6, which in the present case is composed of a metal tube although other suitable materials could be used including plastics. In addition, the grip 5 has a jacket 8 of foamed material that surrounds the core 6. The outermost layer of the grip 5 is formed by a cover 18. The cover 18 can be part of the foamed material of the jacket 8 or applied separately. For example, the cover 18 can be made of leather or vinyl.

The steering device 1 has a center section 9 that is connected to the grip 5 by spokes 10. Different steering wheel configurations have varying numbers of spokes but typically include two to five spokes. This center section 9 serves in the present case to connect the grip 5 to a steering shaft (not shown) and to accommodate an airbag (not shown). The center section 9 may include functional buttons (not shown) in the region of the spokes 10 for “thumb control” of various convenience features such as the stereo or HVAC system of the vehicle.

The steering device 1 is equipped with a heat pipe 4. A “heat pipe” is defined as a device to transport heat energy that functions by way of the following features:

The heat pipe 4 has a gas-tight tube 20 that typically is made of a heat-conducting material such as aluminum, copper or other metal. In the present case it has an outer diameter of approximately 1 cm or less.

A fluid 24 is enclosed in the interior of the tube 20. A certain pressure prevails in the tube 20. The type of the fluid 24 and the amount of pressure determine the evaporation temperature of the fluid 24 in the tube 20. The evaporation temperature is chosen such that it corresponds approximately to the maximum acceptable temperature at the steering device 1. To this end, an evaporation temperature of approximately 25°-60° C. is chosen by preference. It is useful for the fluid 24 to be water, however, other volatile substances may also be used. In one example, the fluid 24 has an evaporating temperature of 25°-35° C. and advantageously is approximately 30° C. The pressure within the tube 20 is approximately 0.04 bar for water. At typical summertime temperatures of between 20° and 60° C., the fluid 24 in the tube 20 should be at a pressure between 0.01 and 0.7 bar and, advantageously between 0.05 and 0.1 bar. The tube has at least two functional areas 7, 11, which can be longitudinal sections of the tube 20.

The first functional area 7 serves to emit heat. The second functional area 11 serves to absorb heat. A condensation device 30 that serves to condense the fluid 24 is provided in the first functional area 7. In the simplest case, this condensation function is performed by the cold tube wall 20 itself. The heat-emitting functional area 7 should be located away from the grip area 5, whereas the heat-absorbing functional area 11 should be located in the region of the grip area 5.

The second functional area 11 is equipped with a transport device 26 that serves to transport the condensed fluid 24 from the first functional area 7 to the second functional area 11. The transport device 26 is preferably made of an absorbent material, for example a fibrous web, which covers the inner tube wall in a layered manner.

The first and second functional areas 7, 11 communicate through a shared enclosed gas exchange volume 28.

In operation, when the heat-absorbing functional area 11 is heated, the liquid formed by the fluid 24 evaporates in the transport device, e.g. the fibrous web. The vapor moves to the shared gas exchange volume 28. When the vapor reaches the heat-emitting functional area 7, it condenses at the condensation device 30, e.g. the at least comparatively colder non-covered tube wall 20. From here, the condensed fluid 24 enters the transport device 26, e.g. the fibrous web, and is transported back to the heat-absorbing functional area 11.

In the present example, the heat pipe is arranged in the steering device 1 as follows. In its jacket 8, the grip 5 has a groove 32 that runs at least partway along the steering device 1. In this case, an annular groove 32 runs about the circumference of the steering wheel. The heat-absorbing functional area 11 of the heat pipe 4 is embedded in this groove 32. However, it is also possible to form the heat pipe 4 into the jacket 8, for example during manufacture thereof. It is also advantageous for the heat pipe 4 to be covered by the cover 18 of the grip 5. To improve thermal conductivity within the grip region, the groove 32 in the jacket 8 or the jacket 8 itself can include metal powder, metal fibers or a thermally conductive paste to convey heat to the heat-absorbing functional area 11. In the case of a cover 18, it can likewise be lined with such materials to aid in thermally conducting heat into the heat-absorbing area 11 of the cooling device.

Multiple heat pipes 4 may also be arranged as shown here in FIG. 2. It is advantageous to do this on opposite sides of the grip 5 relative to its cross-sectional circumference. The multiple heat pipes 4 can also be arranged in a segmented manner along the steering device 1, or along the perimeter of the steering wheel. This simplifies installation of pre-bent tubes 20.

The heat-emitting functional area 7 is located outside the region of the grip area 5. For example, it is routed into the center section 9 through one of the spokes 10. In the simplest case, the heat-emitting functional area 7 is located on an outside of the center section facing away from the driver and is exposed to free flow of ambient air and/or ventilated or cooled air emitted from the vehicle HVAC vents in the dashboard.

However, the heat-emitting functional area 7 can also be arranged inside the center section 9 as shown here. To improve the effective cooling, a Peltier element 15 is located on the heat-emitting functional area 7. When an electric voltage is applied from a source (not shown), the Peltier element 15 cools its surface facing toward the heat pipe 4 and heats its surface facing away from the heat pipe 4. This heat is dissipated to the environment by circulating ambient air through ventilation slots 13. Of course, multiple Peltier elements can be used. The heat-emitting surface 7 can also be enlarged by the use of cooling fins.

A fan 17 may also be provided to support natural air circulation. The fan 17 is preferably arranged on or proximate the Peltier element 15 or heat-emitting functional area 7. However, the fan 17 may also be arranged in the dashboard of the vehicle to avoid or reduce electrical cables in the steering wheel. An axial, radial or diagonal fan is useful depending on the installation situation. The fan 17 should be configured such that the blown air is not directed toward the head of the vehicle operator so as not to compromise operator comfort.

In the case of a vehicle installation, the cooling device 3 can be activated in a variety of ways. For example, the cooling device 3 can be activated normally by the vehicle operator or automatically when the vehicle ignition activates the accessory electrical system or upon unlocking or opening at least one of the vehicle doors. The cooling device 3 can also be employed in other non-vehicle uses where it is desirable to cool a grip handle. In such cases, again, the heat-absorbing functional area 11 should be located in the grip region of the handle, and the heat-emitting area 7 should be located away form the grip region of the handle.

While the invention has been described in connection with one or more embodiments, it is to be understood that the specific mechanisms and techniques which have been described are merely illustrative of the principles of the invention, numerous modifications may be made to the apparatus described without departing from the spirit and scope of the invention as defined by the appended claims.

What is claimed is:

1. A steering device comprising a cooling device arranged therein, the cooling device comprising at least one heat pipe including at least one heat-absorbing area and at least one heat-emitting area, the at least one heat-absorbing area being located in a grip region of the steering device.

2. A steering device according to claim 1 wherein the heat-emitting area is located away from the grip region of the steering device.

3. A steering device according to claim 1 wherein the steering device is a vehicle steering wheel including a circumferential grip region and a center region connected to the grip region by at least one spoke, and wherein the heat-emitting area is located in the center region of the steering wheel.

4. A steering device according to claim 3 wherein the heat-absorbing area is located within a circumferential annular groove formed in the grip region.

5. A steering device according to claim 3 wherein the heat-emitting area is located to be in an air stream of a vehicle vent.

6. A steering device according to claim 1 comprising at least one Peltier element arranged proximate the heat-emitting area of the cooling device.

7. A steering device according to claim 1 comprising at least one fan arranged proximate the heat-emitting area of the cooling device.

8. A steering device according to claim 7 comprising at least one fan arranged proximate the heat-emitting area of the cooling device directed toward a heat-emitting region of the Peltier element or the heat-emitting area of the cooling device.

9. A steering device according to claim 1 comprising at least one fan located remotely from the grip region and directed toward the heat-emitting area of the cooling device.

10. A steering device according to claim 9 comprising at least one Peltier element located remotely from the grip region, and wherein at least part of the Peltier element is arranged in the airflow of the fan.

11. A steering device according to claim 1 wherein the grip region comprises a jacket having high thermal conductivity to convey heat to the heat-absorbing area of the cooling device.

12. A steering device according to claim 11 comprising a cover surrounding the jacket.

13. A steering device according to claim 11 wherein at least part of the jacket includes metal powder, fibers or a thermally conductive paste proximate the heat-absorbing area of the cooling device.

14. A steering device according to claim 1 wherein the heat pipe houses a fluid having an evaporation temperature between 25° C. and 60° C.

15. A steering wheel comprising:
a toroidal grip portion comprising a rigid core surrounded by a jacket;
a center portion connected to the grip portion by at least one spoke; and
a cooling device comprising a heat pipe including a heat-absorbing area arranged in at least part of the grip portion and a heat-emitting area arranged in at least part of the center portion.

16. A steering wheel according to claim 15 wherein the heat-absorbing area is located within a circumferential groove formed in the jacket of the grip region.

17. A steering wheel according to claim 15 wherein the heat pipe comprises a closed tube having a transport device lining at least a portion of the inner tube wall and defining a fluid volume in the heat-absorbing area and a fluid and gas-exchange volume in the heat-emitting area of the cooling device.

18. A steering wheel according to claim 16 wherein the jacket includes metal powder, fibers or a thermally conductive paste proximate the heat-absorbing area of the cooling device.

19. A steering wheel according to claim 15 comprising at least one Peltier element arranged proximate the heat-emitting area of the cooling device.

20. A steering device according to claim 15 comprising at least one fan arranged proximate the heat-emitting area of the cooling device.
